(19) United States
(12) Patent Application Publication
(10) Pub. No.: US 2017/0103353 A1
(43) Pub. Date: Apr. 13, 2017

(54) DIGITAL STRATEGIC MANAGEMENT TOOL

(71) Applicant: Mark W. Sickles, Sausalito, CA (US)

(72) Inventor: Mark W. Sickles, Sausalito, CA (US)

(21) Appl. No.: 15/283,385

(22) Filed: Oct. 1, 2016

Related U.S. Application Data
(60) Provisional application No. 62/240,092, filed on Oct. 12, 2015.

(51) Int. Cl. G06Q 10/06; G06Q 40/00

(52) U.S. Cl. CPC G06Q 10/0637; G06Q 40/00

(57) ABSTRACT

A digital strategic management tool that inputs data, records decisions, and describes actions. Using an online computer and computer keyboard, the tool includes a platform infrastructure, a real-time web application, and login instructions. The real-time web application is housed on line in the platform infrastructure to provide easy access for authenticated users. Using the login instructions, users download the real time web application onto the computer. Then users use the computer keyboard to input the data, record the decisions, and describe the actions. The tool is a cloud-based system, provides a supervening intelligence that is the synthesis of over 26 high leverage principles, theories, and models into a digital tool covering business areas of finance, strategy, organization, and operations. Utilization of this tool shifts companies from the departmental/functional level of thought and action to the systems level of thought and action so that users can observe, orient, decide, and act smarter, faster, and stronger than the competition in response to increasing demand for change. All projects, processes and resources earn more than they cost and enable winning strategies, and there is a complete absence of non-value added work.

### CROSS REFERENCE TO RELATED APPLICATIONS

The instant non-provisional patent application claims priority from provisional patent application number 62/240,092, filed on Oct. 12, 2015, for a DIGITAL STRATEGIC MANAGEMENT TOOL, and incorporated herein in its entirety by reference thereto.

### BACKGROUND OF THE INVENTION

1. Field of the Invention

The embodiments of the present invention relate to a digital tool, and more particularly, the embodiments of the present invention relate to a digital strategic management tool.

2. Description of the Prior Art

As the rate of change and degree of uncertainty in business continue to increase, business leaders are increasingly ill-equipped to observe, orient, decide, and act effectively and efficiently enough to create the sustainable value their employees, customers, and investors expect and deserve. Consequently, shareholder and stakeholder holder value is widely and chronically destroyed and sub-optimized.

Existing approaches to planning fail to provide a seamless, integrated, and holistic digital tool for systems-level performance and dynamic value creation. Instead, these existing approaches waste valuable time and talent, often destroying shareholder value, frustrating board directors, CEOs, and their leadership teams.

Existing planning tools are not sufficiently principle-based nor designed at the systems-level of thought and action. They are, therefore, not sources of needed organizational intelligence, interdependence, alignment, speed and strength.

Numerous innovations for business methods have been provided in the prior art, which will be described, infra, in chronological order to show advancement in the art, and which are incorporated herein in their entirety by reference thereto. Even though these innovations may be suitable for the specific individual purposes to which they address, nevertheless, they differ from the embodiments of the present invention.

### U.S. Patent Application Publication Number U.S. 2005/0222893 A1 to Kasravi et al.

United States Patent Application Publication Number U.S. 2005/0222893 A1—published to Kasravi et al. on Oct. 6, 2005 in US class 705 and subclass 7.11—teaches a method, system, and computer program product for improving an organization's business adaptability. In one embodiment, a taxonomy is created, wherein the taxonomy includes a hierarchical list of taxonomy indicators that captures organizational elements that can be used to measure an organization's responsiveness to change, and wherein the taxonomy indicators are industry specific. A set of weights associated with the elements of the taxonomy, indicating a relevant contribution of each element to an overall adaptability of an organization, are assigned. The weights are industry specific. An enterprise profile for the organization is determined and an adaptability result of the organization is calculated from the weights, taxonomy, and enterprise profile. The adaptability result provides a quantitative assessment of the organization's adaptability. Recommendations for improving the adaptability of the organization are then determined using a rules engine and or heuristics and utilizing the adaptability result, the taxonomy, the enterprise profile, and data gathered in creating the taxonomy, the enterprise profile, and the set of weights.

In contradistinction to the digital strategic management tool of the embodiments of the present invention, Kasravi et al. omit half of the 26 essential principles, theories, and models (disciplines) needed to create the digital strategic management tool of the embodiments of the present invention. Because of these omissions, Kasravi et al. do not build organizational intelligence, speed, and strength that supervene on the agents of the organization, enabling them to achieve extraordinary results. Focus is on agility and adaptability—partial means to the end goal of sustainable value creation that are necessary but, when compared to the purpose and effect of the digital strategic management tool of the embodiments of the present invention, not sufficient. Together, Kasravi et al. make assessments and recommendations for improvement “which incorporate industry best practices.” Research, however, indicates the application of best practices is “misguided and may even be counterproductive . . . and actually diminish firm value.” Becker, Huselid, Pickus, Spratt, 1996. The digital strategic management tool of embodiments of the present invention preempts this value diminishing concern with best practices by creating the “next” practice of supervenience capital as a new and powerful source of value creation.

U.S. Pat. No. 7,899,723 B2 to Ostergard et al.

U.S. Pat. No. 7,899,723—issued to Ostergard et al. on Mar. 1, 2011 in US class 705 and subclass 35—teaches a system and related method for automatically examining a company's financial data and evaluating factors affecting the company's stock value. Specifically, the system evaluates a company's spread through that company's debt and equity costs. The system further measures returns to investors from company growth, either organic growth or growth through mergers and acquisitions. The system may further evaluate the financial data of other publicly traded companies, such as, those in the same industry, and compares the various factors affecting stock value. The system also includes a system for determining the return to investors. The system may be a software-based application that collects financial data and uses this information to calculate the return to investor through the company's spreads and growth. The system is connected to a distributed network, such as, the Internet.

In contradistinction to the digital strategic management tool of the embodiments of the present invention, Ostergard et al. omit 23 of the 26 essential disciplines needed to create the digital strategic management tool of the embodiments of the present invention. Because of these omissions, Ostergard et al. do not build organizational intelligence, speed, and strength that supervene on the agents of the organization, enabling them to achieve extraordinary results. Instead, Ostergard et al. examine, evaluate, measure, compare, determine, and calculate.

U.S. Pat. No. 8,065,210 B2 to Ballow et al.

U.S. Pat. No. 8,065,210—issued to Ballow et al. on Nov. 22, 2011 in US class 705 and subclass 35—teaches a computer-implemented method for analyzing the relative performance of a business unit. The method includes: receiving financial data about the business unit; determining NOPLAT, revenue, capital charge, and invested capital values for the business unit at a first time and a second time from the financial data; determining at least two data points including a first component indicative of NOPLAT/revenue and a second component indicative of revenue/capital charge for the business unit (the at least two data points indicative of values determined at one of the first time and the second time, respectively); and displaying the at least two data points, a first indicia for each data point indicative of the capital value, a second indicia indicative of a spread percentage, and a third indicia indicative of a relationship between the at least two data points between the first time and the second time.

In contradistinction to the digital strategic management tool of the embodiments of the present invention, Ballow et al. omit 18 of the 26 essential disciplines needed to create the digital strategic management tool of the embodiments of the present invention. Because of these omissions, Ballow et al. do not build organizational intelligence, speed, and strength that supervene on the agents of the organization, enabling them to achieve extraordinary results. Instead, Ballow et al. analyze, determine, and display.

U.S. Pat. No. 8,204,809 B1 to Wise

U.S. Pat. No. 8,204,809—issued to Wise on Jun. 19, 2012 in US class 705 and subclass 35—teaches a finance function high performance capability assessment model to help a business meet the challenges of the global marketplace. As a result, businesses can achieve the clarity, consistency, and well-defined execution of a finance functions improvement program. In addition, the finance function high performance capability assessment model helps the business to identify specific areas in which cost reductions and improvements to key areas that impact finance functions may be made and understand how to make the improvements.

In contradistinction to the digital strategic management tool of the embodiments of the present invention, Wise's focus is on the assessment of the performance capability of the finance function only. The digital strategic management tool of the embodiments of the present invention's focus is on the intelligence, speed, strength, actions, and results of the whole organization.

U.S. Pat. No. 8,386,297 B2 to Heyns et al.

U.S. Pat. No. 8,386,297—issued to Heyns et al. on Feb. 26, 2013 in US class 705 and subclass 7.35—teaches target setting, forecasting, and budgeting methods and tools in which targets are selected at a high level of management through a process of strategic planning to select targets based on a combination of value expected to be added and manageability of the candidate targets, including computer simulations of increased cash flow expected to be generated by the target strategies. The strategically planned targets are then flowed down to the various levels of management, budgets are constructed around those target strategies, and the budgets are then consolidated and flowed upward. By defining organizational targets and then aligning those targets with strategic goals from the beginning, the number and scope of iterations of budget adjustments can be reduced.

In contradistinction to the digital strategic management tool of the embodiments of the present invention, Heyns et al. omit 19 of the 26 essential disciplines needed to create the digital strategic management tool of the embodiments of the present invention. Because of these omissions, Heyns et al. do not build organizational intelligence, speed, and strength that supervene on the agents of the organization, enabling them to achieve extraordinary results.

U.S. Pat. No. 8,554,593 B2 to Kasravi et al.

U.S. Pat. No. 8,554,593—issued to Kasravi et al. on Oct. 8, 2013 in US class 705 and subclass 7.11—teaches a method, system, and computer program product for measuring and assessing an organization's business adaptability. In one embodiment, a taxonomy including a hierarchical list of taxonomy indicators that captures organizational elements that can be used to measure an organization's responsiveness to change is created. The taxonomy indicators are industry specific. A set of weights associated with the elements of the taxonomy, indicating a relevant contribution of each element to an overall adaptability of an organization, is assigned. The set of weights are industry specific. An enterprise profile is created assigning a level of adaptability to each taxonomy indicator indicating where, in a range of scores from low to high, an enterprise rates relative to the relevant taxonomy indicator. An adaptability result of the organization from the weights, taxonomy, and enterprise profile is then calculated. The adaptability result provides a quantitative assessment of the organization's adaptability.

In contradistinction to the digital strategic management tool of the embodiments of the present invention, Kasravi et al. omit half of the 26 essential disciplines needed to create the digital strategic management tool of the embodiments of the present invention. Because of these omissions, Kasravi et al. do not build organizational intelligence, speed, and strength that supervene on the agents of the organization, enabling them to achieve extraordinary results. Focus is on measuring and assessing agility and adaptability—helpful to the end goal of sustainable value creation but, when compared to the purpose and effect of the digital strategic management tool of the embodiments of the present invention, not sufficient. Together, Kasravi et al. make assessments by identifying opportunities for best practice transfer. Research, however, indicates the application of best practices is “misguided and may even be counterproductive . . . and actually diminish value.” Becker, Huselid, Pickus, Spratt, 1996. The digital strategic management tool of the embodiments of the present invention preempts this value diminishing concern with best practices by creating the “next” practice of supervenience capital as a new and powerful source of value creation.

It is apparent that numerous innovations for business methods have been provided in the prior art, which are adapted to be used. Furthermore, even though these innovations may be suitable for the specific individual purposes to which they address, nevertheless, they would not be suitable nor effective for the purposes of the embodiments of the present invention as heretofore described.

There exists a need to solve the problems of the prior art at the root cause level by creating organizations that are smarter, faster, and stronger than the problems.

### SUMMARY OF THE INVENTION

Thus, an object of the embodiments of the present invention is to provide a digital strategic management tool, which avoids the disadvantages of the prior art while providing new advantages for creating sustainable value

Briefly stated, another object of the embodiments of the present invention is to provide a digital strategic management tool that inputs data, records decisions, and describes actions leading to extraordinary results. Operating in an online computer with a computer keyboard, the digital strategic management tool includes a platform infrastructure, a real-time web application, and login instructions. The real-time web application is housed on line in the platform infrastructure providing easy access to authenticated users. Using the login instructions, users access the real time web application, downloading the real time web application onto the computer. Then the users use the computer keyboard to input the data, record the decisions, and describe the actions.

The digital strategic management tool of the embodiments of the present invention separates the significant few from the trivial many in the critical business areas of finance, strategy, organization, and operations, and then puts them all together in a single, seamless, and easy-to-use digital tool enabling users to shift from the departmental/functional level of thought and action to the systems level of thought and action needed to solve the problems that prevent sustainable value creation, while exploiting opportunities that create value. This tool also ensures all projects, processes, and resources earn more than they cost and enable winning strategies, while preventing the design of non-value added work.

### Why the Digital Strategic Management Tool of the Embodiments of the Present Invention is an Advantage Over, and is Superior To, the Cited Prior Art

The digital strategic management tool of the embodiments of the present invention uniquely produces supervenience capital: organizational intelligence, speed, and strength enabling ordinary people to achieve extraordinary results. In this supervening environment, people function interdependently as superorganisms, defined as “collections of agents which can act in concert to produce phenomena governed by the collective.”

The digital strategic management tool of the embodiments of the present invention's installation and utilization transform the organization into a user's most powerful and enduring strategic asset and competitive advantage, with high degrees of predictability, performance, and sustainable value creation.

The collective intelligence created by installing and utilizing the digital strategic management tool of the embodiments of the present invention supervenes on the individual people, enabling them to achieve extraordinary results they could never achieve on their own or outside of these superorganisms, similar to swarming intelligence seen in nature.

The digital strategic management tool of the embodiments of the present invention's underlying magic is the synthesis of 26 essential business principles, theories, and models cross-pollinated into a breakthrough form of organizational intelligence, both different and greater than the sum of its parts, representing an entirely new management paradigm. Because the cited prior art discussed, supra, are not syntheses of these 26 high leverage and complementary disciplines, they do not transform organizations into strategic assets comparable to the digital strategic management tool of the embodiments of the present invention nor produce the same level of sustainable value creation that the digital strategic management tool of the embodiments of the present invention is proven to create. The digital strategic management tool of the embodiments of the present invention provides a breakthrough level of thought and action that is the product of the digital strategic management tool of the embodiments of the present invention's integration of the 26 business principles, theories, and models that have never been integrated before.

The cross-pollinating innovation of the digital strategic management tool of the embodiments of the present invention created the organizational equivalent of the human nervous system enabling a level of individual, team, and organizational performance that would otherwise be impossible.

The digital strategic management tool of the embodiments of the present invention's approach used to create this business breakthrough was cited as one of Wired's 7 rules for identifying technologies that will change the world—creating entirely new disciplines—in a 2012 article by Thomas Goetz, “How To Spot The Future”: “It's no secret that the best ideas—the ones with the most impact and longevity—are transferable; an innovation in one industry can be exported to transform another. But even more resonant are those ideas that are cross-disciplinary not just in their application but in their origin.” “The point here is that by drawing on threads from several areas, interdisciplinary pioneers can weave together a stronger, more robust notion that exceeds the bounds of any one field.”

Writer Tom Robbins also captured the essence of the digital strategic management tool of the embodiments of the present invention in the following quote: “If you take any activity, any art, any discipline, any skill—take it and push it as far as it will go, push it beyond where it has ever been before, push it to the wildest edges of edges, then you force it into the realm of magic.”

By weaving together the 26 complementary disciplines—the digital strategic management tool of the embodiments of the present invention's underlying magic—into a single new discipline called the digital strategic management tool of the embodiments of the present invention, this—exceeding the bounds of any one field and reaching into the realm of magic—is what the digital strategic management tool of the embodiments of the present invention has done to the management discipline.

Simply by installing and utilizing the digital strategic management tool of the embodiments of the present invention in the organization, this new way of thinking and acting becomes embedded in the organization's DNA in ways that supervene on the people in that organization, enabling them to achieve results they could not achieve outside these smarter, faster, and stronger super organizations.

Why the Digital Strategic Management Tool of the Embodiments of the Present Invention is an Improvement over the Prior Art

The digital strategic management tool of the embodiments of the present invention is an improvement over the prior art because the digital strategic management tool of the embodiments of the present invention is the synthesis of 26 high leverage disciplines into an entirely new discipline for creating sustainable value.

The essence of each of the 26 raw material disciplines have been embedded and intertwined into an interdependent and seamless system of thought and action, ensuring the user is well-governed, well-led, and well-managed. All 26 inter-disciplines are essential to the ontology/being of the digital strategic management tool of the embodiments of the present invention's supervenience.

This new way to think and act has been digitized to provide an intuitive, effective, efficient, and user-friendly value-creating tool for boards, management, and the workforce to collaborate in pursuit of long-term value creation for shareholders and other stakeholders.

Moreover, sequence, interdependence, and context are essential features of the digital strategic management tool of the embodiments of the present invention, so any other order or design would fail to produce the unique power of supervenience, turning the digital strategic management tool of the embodiments of the present invention from an intelligent whole into a dysfunctional heap.

The novel features considered characteristic of the embodiments of the present invention are set forth in the appended claims. The embodiments of the present invention themselves, however, both as to their construction and to their method of operation together with additional objects and advantages thereof will be best understood from the following description of the embodiments of the present invention when read and understood.

### DETAILED DESCRIPTION OF THE PREFERRED EMBODIMENTS

### Introductory

The digital strategic management tool of the embodiments of the present invention is a responsive and real-time Angular JS application with a high degree of usability to accommodate the corporate leader user profile, and provides a seamless workflow loop from finance to strategy, organization, and operations.

The digital strategic management tool of the embodiments of the present invention separates the significant few from the trivial many in the critical business areas of finance, strategy, organization, and operations, and then puts it all together in a single, seamless, easy-to-use digital tool, enabling firms to shift from the department/functional level of thought and action to the systems level of thought and action needed to solve the chronic problems preventing sustainable value creation while exploiting opportunities to create value. The digital strategic management tool of the embodiments of the present invention also ensures all projects, processes, and resources earn more than they cost. Ergo, an economic profit.

As stated, supra, as the rate of change and degree of uncertainty continue to increase, business leaders are ill-equipped to effectively and efficiently observe, orient, decide, and act as needed to deliver sustainable value to their employees, customers, and investors. The digital strategic management tool of the embodiments of the present invention solves this problem, equipping corporate leaders to build organizations that are great places to work, buy, and invest.

By separating the wheat from the chaff in the critical areas of finance, strategy, organization, and operations, and then putting it all together in a single, seamless, and digitized process, the digital strategic management tool of the embodiments of the present invention provides a super capability enabling management to quickly and easily make the internal adjustments in response to external change and uncertainty needed to deliver sustainable value to investors and other shareholders.

The digital strategic management tool of the embodiments of the present invention differs from what currently exists. Other planning tools produce a static plan that rapidly becomes obsolete. They also fail to build the organizational intelligence, speed, and strength needed to consistently create sustainable value in today's dynamic business environment. The digital strategic management tool of the embodiments of the present invention fills that void.

Ultimately, the digital strategic management tool of the embodiments of the present invention creates supervenience: a state of organizational intelligence, speed, and strength enabling ordinary people and ordinary effort to produce extraordinary results.

The digital strategic management tool of the embodiments of the present invention is a cloud-based system of organizational intelligence, speed, and strength proven to dramatically increase long-term shareholder and stockholder value.

The digital strategic management tool of the embodiments of the present invention functions as the organization's nervous system, providing a powerful form of supervening intelligence enabling ordinary people to achieve extraordinary results they could not achieve outside these super organizations.

The digital strategic management tool of the embodiments of the present invention integrates 26 high leverage principles, theories, and models covering the critical business areas of finance, strategy, organization, and operations, and then puts them all together in a single, seamless, easy-to-use tool whose utilization shifts companies from the departmental/functional level of thought and action to the systems level of thought and action.

The digital strategic management tool of the embodiments of the present invention's supervening intelligence enables the digital strategic management tool of the embodiments of the present invention to respond to the increasing demand for change, managing all projects, processes, and resources to earn more than they cost and enable winning strategies while preventing non-value added work, thereby creating sustainable value better and faster than the competition.

### What the Digital Strategic Management Tool of the Embodiments of the Present Invention Does

The digital strategic management tool of the embodiments of the present invention creates organizational intelligence, speed, and strength needed to beat the competition.

The digital strategic management tool of the embodiments of the present invention focuses management and the board on the significant few financial measures proven to create long-term value.

The digital strategic management tool of the embodiments of the present invention provides a disciplined and comprehensive process for mission-critical decision-making and action.

The digital strategic management tool of the embodiments of the present invention builds organizations tailored to strategy.

The digital strategic management tool of the embodiments of the present invention creates interdependence, alignment, speed and strength across the organization, with a shared focus on enterprise goals and outcomes.

The digital strategic management tool of the embodiments of the present invention seamlessly links strategy formulation, implementation, and modification.

The digital strategic management tool of the embodiments of the present invention converts winning plans into actionable levels of work.

The digital strategic management tool of the embodiments of the present invention monitors and controls business operations for optimal performance.

The digital strategic management tool of the embodiments of the present invention prevents non-value-added projects, processes, and resources that destroy value.

### What Are the Benefits of the Digital Strategic Management Tool of the Embodiments of the Present Invention

The digital strategic management tool of the embodiments of the present invention provides the organization as the user's most powerful and enduring competitive advantage.

The digital strategic management tool of the embodiments of the present invention provides a great place to work, buy, and invest.

The digital strategic management tool of the embodiments of the present invention provides highly effective board and C-suite collaboration.

The digital strategic management tool of the embodiments of the present invention provides enhanced value-adding opportunities for boards and investors to interact with the CEO and management.

The digital strategic management tool of the embodiments of the present invention provides the ability to beat the competition.

The digital strategic management tool of the embodiments of the present invention provides sustainable value-creation.

The digital strategic management tool of the embodiments of the present invention provides operating income above the cost of capital.

The digital strategic management tool of the embodiments of the present invention provides positive free cash flow.

The digital strategic management tool of the embodiments of the present invention provides that all projects, processes, and resources earn more than they cost and enable winning strategies.

### Configuration of the Digital Strategic Management Tool of the Embodiments of the Present Invention

### Components

The digital strategic management tool of the embodiments of the present invention comprises a platform infrastructure, a real-time web application, login instructions, all to operate in an online computer using a computer keyboard.

The platform infrastructure includes data storage, user authorization, and hosting.

The real-time web application is divided into four major components.

The login instructions access the real-time web application.

### Relationship Between the Components

The real time web application is housed on line in the platform infrastructure for providing easy access to authenticated users. Using the login instructions, users access the system, downloading it onto their computer. They then use their computer keyboard to input data, record decisions, and describe actions.

### How the Digital Strategic Management Tool of the Embodiments of the Present Invention Works

The four major components of the real-time web application include financial worksheets, forces for tracking, decision tree for leading to action and outcome, and key questions for ensuring efficient effectiveness.

The financial worksheets, forces, and decision tree components of the real-time web application function as a supplier-customer chain across a sequentially correct flow of input-process-output, each component building on the other, collectively producing principle-based analysis embedded in a system of decisions and action uniquely designed to ensure the success of the whole.

While working seamlessly across finance, strategy, organization, and operations at the systems level has been considered highly valuable and desirable, but unobtainable in practice because of its high degree of difficulty, the digital strategic management tool of the embodiments of the present invention has made it easy to do and available to all.

The financial worksheets of the four major components of the real-time web application create a context for analysis of the forces of the four major components of the real-time web application.

Both the financial worksheets of the four major components of the real-time web application and the forces of the four major components of the real-time web application are embedded into the decision tree of the four major components of the real-time web application. Decisions are then transformed into effective actions and extraordinary results.

The key questions of the four components of the real-time web application are a source of principle-based knowledge, intelligence, and inquiry designed to enhance the effectiveness of the other three components, and further support sustainable value creation.

### How to Make the Digital Strategic Management Tool of the Embodiments of the Present Invention

The method of making the digital strategic management tool of the embodiments of the present invention comprises the steps of:

STEP 1: Developing expertise in all 26 essential principles, theories, and models, as well as how to manage them sequentially and interdependently to create supervenience capital;

STEP 2: Utilizing this cross-discipline expertise to integrate the 26 essential raw materials of the digital strategic management tool of the embodiments of the present invention into an interdependent system of workflows and supervenience capital essential to fulfilling the digital strategic management tool of the embodiments of the present invention's purpose of sustainable value creation;

STEP 3: Effectively digitizing this interdependent system of seamless workflows and supervenience capital to provide an intuitive, effective, efficient, and user-friendly value-creating opportunity and experience.

This is why the digital strategic management tool of the embodiments of the present invention is highly inimitable: how to carry out these three steps is both path dependent and causally ambiguous.

As the digital strategic management tool of the embodiments of the present invention is a principle-based system, all elements are necessary. Added elements that may make the digital strategic management tool of the embodiments of the present invention work more efficiently include dashboards, historical tracking, and internal commenting capability.

Because sequence, interdependence, and context are essential features of the digital strategic management tool of the embodiments of the present invention, any omission, shuffling, interchange, or reconfiguration would rob the digital strategic management tool of the embodiments of the present invention of the science, precision, and systems-level capability that create the digital strategic management tool of the embodiments of the present invention's unique power, turning the digital strategic management tool of the embodiments of the present invention from a synergistic “whole” into a dysfunctional “heap”.

### How to Use the Digital Strategic Management Tool of the Embodiments of the Present Invention

The method of using the digital strategic management tool of the embodiments of the present invention comprises the steps of:

STEP 1: Simply logging into the system;

STEP 2: Following the seamless flow of the process, from finance to strategy, organization, and operations; and

STEP 3: Using the digital strategic management tool of the embodiments of the present invention as a success formula for going through the ongoing process of observation, orientation, decision-making, and action taking, so that all projects, processes, and resources earn more than they cost and enable winning strategies.

### Impressions

It will be understood that each of the elements described, supra, or two or more together may also find a useful application in other types of constructions differing from the types described above.

While the embodiments of the present invention have been illustrated and described as embodied in a digital strategic management tool, nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A digital strategic management tool for using an online computer and computer keyboard for inputting data, for recording decisions, and for describing actions, comprising:
a) a platform infrastructure;
b) a real-time web application;
c) login instructions;
wherein said real-time web application is housed on line in said platform infrastructure for providing easy access to authenticated users;
wherein said login instructions allow the authenticated users to access said real time web application that is downloaded onto said computer; and
wherein said computer keyboard is for inputting the data, for recording the decisions, and for describing the actions.

2. The digital strategic management tool of claim 1, wherein said platform infrastructure includes data storage.

3. The digital strategic management tool of claim 1, wherein said platform infrastructure includes user authorization.

4. The digital strategic management tool of claim 1, wherein said platform infrastructure includes hosting.

5. The digital strategic management tool of claim 1, wherein said real-time web application is divided into four major components.

6. The digital strategic management tool of claim 1, wherein said login instructions access said real-time web application.

7. The digital strategic management tool of claim 1, wherein said computer has online capability.

8. The digital strategic management tool of claim 5, wherein said four major components of said real-time web application include:
a) financial worksheets;
b) forces;
c) decision tree; and
d) key questions;
wherein said financial worksheets of said four components of said real-time web application are for identifying and recording data;
wherein said forces of said four major components of said real-time web application are for identifying, assessing, and tracking;
wherein said decision tree of said four major components of said real-time web application is for leading to action and outcome; and
wherein said key questions of said four major components of said real-time web application are for ensuring efficient effectiveness.

9. The digital strategic management tool of claim 8, wherein said financial worksheets, forces, and decision tree components of the real-time web application function as a supplier-customer chain across a sequentially correct flow of input-process-output, each component building on the other, collectively producing principle-based analysis embedded in a system of decisions and actions uniquely designed to ensure the success of the whole.

10. The digital strategic management tool of claim 8, wherein said finance, said strategy, organization, and operations seamlessly work at said systems level.

11. The digital strategic management tool of claim 8, wherein said financial worksheets of said four major components of said real-time web application create a context for analysis of said forces of said four major components of said real-time web application.

12. The digital strategic management tool of claim 8, wherein both said financial worksheets of said four major components of said real-time web application and said forces of said four major components of said real-time web application are embedded into said decision tree of said four major components of said real-time web application so as to form decisions, with said decisions then transformed into actions; and
wherein said key questions of said four major components of said real-time web application are a source of principle-based knowledge, intelligence, and inquiry to further support the efficient effectiveness of the other three major components of said real-time web application and the resulting sustainable value creation.

13. The digital strategic management tool of claim 1, wherein as said digital strategic management tool is principle-based systems, all elements are necessary.

14. The digital strategic management tool of claim 1, further comprising:
a) dashboards;
b) historical tracking; and
c) internal commenting capability;
wherein the addition of said dashboards, said historical tracking, and internal commenting capability may make said digital strategic management tool work more efficiently than in its current form.

15. The digital strategic management tool of claim 1, wherein because sequence, interdependence, and context are essential features of said digital strategic management tool, any omission, shuffling, interchange, or reconfiguration would rob said digital strategic management tool of science, precision, and systems-level capability that create the digital strategic management tool's unique power of supervening intelligence, turning the digital strategic management tool from a synergistic “whole” into a dysfunctional “heap.”

16. The digital strategic management tool of claim 1, wherein said digital strategic management tool separates the wheat from the chaff in the critical business areas of finance, strategy, organization, and operations, and then puts them all together in a single, seamless, and easy-to-use digital tool enabling users to shift from a departmental/functional level of thought and action to a systems level of thought and action needed to solve problems that prevent sustainable value creation and exploit opportunities that create value.

17. The digital strategic management tool of claim 1, wherein said digital strategic management tool is a responsive and real-time Angular JS application with a high degree of usability to accommodate a corporate leader user profile, and provides a seamless workflow loop from finance to strategy, organization, and operations.

18. The digital strategic management tool of claim 1, wherein said digital strategic management tool is a cloud-based system of organizational intelligence, speed, and strength proven to dramatically increase long-term shareholder and stakeholder value.

19. The digital strategic management tool of claim 1, wherein said digital strategic management tool functions as an organization's nervous system, providing a new and powerful form of supervening intelligence enabling ordinary people to achieve extraordinary results they could not achieve outside these super organizations.

20. The digital strategic management tool of claim 1, wherein said digital strategic management tool integrates 26 high leverage principles, theories, and models covering the critical business areas of finance, strategy, organization, and operations, and then puts them all together in a single, seamless, easy-to-use tool whose utilization shifts companies from the departmental/functional level of thought and action to the systems level of thought and action.

21. The digital strategic management tool of claim 1, wherein said digital strategic management tool's supervening intelligence enables said digital strategic management tool to respond to increasing demand for change, managing all projects, processes and resources to earn more than they cost, and creating sustainable value better and faster than the competition.

22. The digital strategic management tool of claim 1, wherein said digital strategic management tool creates organizational intelligence, speed, and strength needed to beat the competition.

23. The digital strategic management tool of claim 1, wherein said digital strategic management tool focuses management and boards on the significant few financial measures proven to create long-term value.

24. The digital strategic management tool of claim 1, wherein said digital strategic management tool provides a disciplined and comprehensive process for mission-critical decision-making and action.

25. The digital strategic management tool of claim 1, wherein said digital strategic management tool builds organizations tailored to strategy.

26. The digital strategic management tool of claim 1, wherein said digital strategic management tool seamlessly links strategy formulation, implementation, and modification.

27. The digital strategic management tool of claim 1, wherein said digital strategic management tool converts winning plans into actionable levels of work.

28. The digital strategic management tool of claim 1, wherein said digital strategic management tool monitors and controls business operations for optimal performance.

29. The digital strategic management tool of claim 1, wherein said digital strategic management tool prevents non-value-added projects, processes, and resources that destroy value.

30. The digital strategic management tool of claim 1, wherein said digital strategic management tool provides the organization as a user's most powerful and enduring competitive advantage.

31. The digital strategic management tool of claim 1, wherein said digital strategic management tool provides a highly effective board and C-suite collaboration.

32. The digital strategic management tool of claim 1, wherein said digital strategic management tool provides enhanced value-adding opportunities for boards and investors to interact with the CEO and management.

33. The digital strategic management tool of claim 1, wherein said digital strategic management tool provides long-term value-creation.

34. The digital strategic management tool of claim 1, wherein said digital strategic management tool provides operating income above the cost of capital.

35. The digital strategic management tool of claim 1, wherein said digital strategic management tool provides positive free cash flow.

36. The digital strategic management tool of claim 1, wherein said digital strategic management tool provides all projects, processes, and resources earning more than they cost and enabling strategy while preventing the design of non-value added work.

37. A method of making the digital strategic management tool of the embodiments of the present invention comprising the steps of:
a) Developing expertise in all 26 principles, theories, and models, as well as how to manage them sequentially and interdependently to create supervenience capital;
b) Utilizing this cross-discipline expertise to integrate the 26 essential raw materials of the digital strategic management tool of the embodiments of the present invention into an interdependent systems of workflows and supervenience capital essential to fulfilling the digital strategic management tool of the embodiments of the present invention's purpose of sustainable value creation;
c) Effectively digitizing this interdependent system of seamless workflows and supervenience capital to provide an intuitive, effective, efficient, and user-friendly value-creating opportunity and experience.

38. A method of using a digital strategic management tool, comprising the steps of:
a) logging into the tool;
b) following a seamless flow of the process, from finance, to strategy, organization, and operations; and
c) using the digital strategic management tool as a success formula for going through the ongoing process of observation, orientation, decision-making, and action taking, so that all projects, processes, and resources earn more than they cost and enable winning strategies.
